(19) United States
(12) Patent Application Publication
(10) Pub. No.: US 2007/0155358 A1
(43) Pub. Date: Jul. 5, 2007

(54) Rechargeable audio/video link and docking station

(75) Inventors: Michael Krieger, Miami Beach, FL (US); Kevin Ellsworth, Alva, FL (US)

Correspondence Address: VECTOR PRODUCTS, INC.;ROBERT POWELL, P.O. BOX 34385, c/o VENABLE LLP, WASHINGTON, DC, 20043-9998, US

(73) Assignee: Black & Decker Inc., Newark, DE (US)

(21) Appl. No.: 11/589,810

(22) Filed: Oct. 31, 2006

Related U.S. Application Data
(60) Provisional application No. 60/731,497, filed on Oct. 31, 2005.

(51) Int. Cl. H04H 7/00; H04N 7/18; H04B 1/16

(52) U.S. Cl. 455/343.1; 455/3.06; 725/81

(57) ABSTRACT

A wireless transmission system is disclosed containing a rechargeable transmitter and receiver. The transmitter is able to receive an input A/V signal and wireless transmit the A/V signal to a receiver which outputs the A/V signal to a receiving device.

### CROSS REFERENCE TO RELATED APPLICATION

This application claims the priority of U.S. Provisional Patent Application No. 60/731,497, filed Oct. 31, 2005, which is hereby incorporated by reference.

### BACKGROUND OF THE INVENTION

1. Field of the Invention

The present invention relates generally to a wireless video and audio link between electronic devices.

2. Related Art

With the greater availability and affordability of electronic devices, today's homes more and more include electronic entertainment and theater systems. Such systems include a number of different electronic components that are typically connected together and communicate with each other via wires. Unless cables or wires are used to connect such electronic components as televisions and home theater equipment, signals from these different devices cannot be transmitted to remotely located devices, such as a television in a bedroom. Thus, the video or audio programming can only be enjoyed in those areas already hard wired. Additionally, the areas behind such devices are usually a jumble of wires. The presence of a large number of wires in a home can be unattractive.

Entertainment systems are today also included in new automobiles. Many vehicles now come equipped with video entertainment systems. Such systems typically come with video monitors as standard equipment and are capable of showing movies and television programming. Video game systems can also be connected to the video monitor to enable game play. However, the video game system is an external component provided by the vehicle owner and requires an AC power source not usually present in vehicles. Also, the video game system must be connected via wires to the video monitor. In the smaller confines of a vehicle, the wires connecting different components are even more intrusive and may even present a driving hazard.

Thus, there is a need for a wireless audio/video link and power supply.

### SUMMARY OF THE INVENTION

In an exemplary embodiment of the invention, there is provided a wireless transmission system comprising a transmitter including input ports to receive input A/V signals, transmitter circuitry adapted to process the A/V signals for wireless transmission, an antenna coupled to the transmitter circuitry to wirelessly transmit the processed A/V signals, a rechargeable power supply coupled to the transmitter circuitry, and recharging circuitry coupled to the rechargeable power supply to supply recharging power thereto. The system may also include a receiver comprising an antenna adapted to receive the wirelessly transmitted signals from the transmitter, receiver circuitry coupled to the antenna and adapted to process the received signals, output ports to receive processed signals from the receiver circuitry and adapted to be coupled to a receiving device, a rechargeable power supply coupled to the receiver circuitry, and recharging circuitry coupled to the rechargeable power supply to supply recharging power thereto.

In another embodiment of the invention, a docking station for wireless senders/receivers is provided. The docking station includes a housing; a recharging port provided on the housing and adapted to be coupled to corresponding recharging ports on the wireless sender and receiver; a DC input coupled to the recharging port; a power inverter disposed in the housing, receiving the DC input and providing an AC output; and an AC output port coupled to the power inverter and receiving the AC output.

Further objectives and advantages, as well as the structure and function of exemplary embodiments will become apparent from a consideration of the description, drawings, and examples.

### BRIEF DESCRIPTION OF THE DRAWINGS

The foregoing and other features and advantages of the invention will be apparent from the following, more particular description of an exemplary embodiment of the invention, as illustrated in the accompanying drawings wherein like reference numbers generally indicate identical, functionally similar, and/or structurally similar elements.

FIG. 1 depicts an exemplary system formed using a wireless link according to an embodiment of the present invention;

FIG. 2 depicts a block diagram of an exemplary embodiment of a transmitter according to the present invention;

FIG. 3 depicts a block diagram of an exemplary embodiment of a receiver according to the present invention; and

FIG. 4 depicts a block diagram of an exemplary embodiment of a docking station according to the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

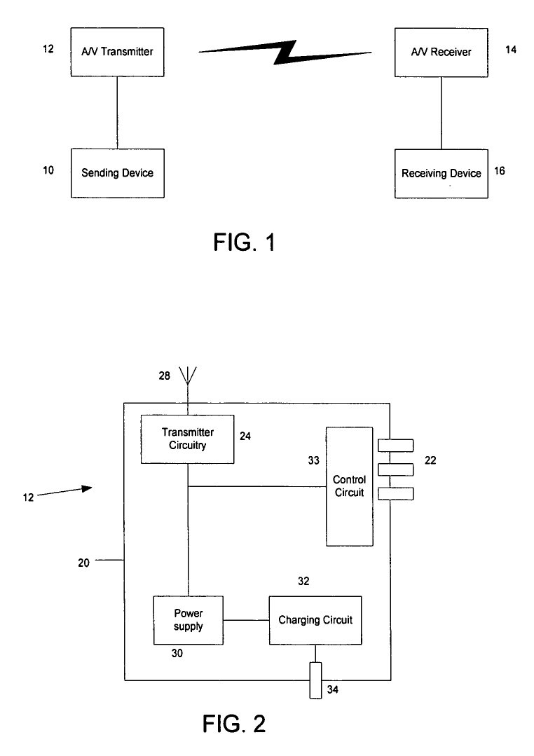

Embodiments of the present invention provide a wireless link between a sending device and a receiving device. The sending and receiving devices may include any type of electronic devices that are not configured to communicate in a wireless manner. The sending and receiving devices may include such devices as televisions, digital video disk (DVD) players, video cassette recorders (VCRs), video cameras, stereos, satellite systems, video game systems, etc. For example, the embodiment illustrated in FIG. 1 includes a sending device 10, for instance a video game system such as Playstation 2 from Sony, coupled to a transmitter 12. The transmitter 12 receives output signals from the video game system. The output signals may include audio and video signals for a game being played on the game system. The transmitter 12 transmits those video and audio signals in a wireless manner to a receiver 14. The receiver 14 receives the wireless signals and provides the video game system output signals to receiving device 16, such as a television or other display. The television can then display the video and play the audio associated with the output signals from the video game system.

FIG. 2 illustrates an exemplary embodiment of a transmitter 12 according to the invention. The transmitter 12 includes a housing 20 enclosing various power, control and signal transmission circuits. The housing 20 includes one or more ports 22 via which a signal may be input into the transmitter 12. The input signals may include, for example, TV, DVD, VCR, camcorder, stereo, satellite system or game system signals. The ports 22 included in transmitter 12 may vary based on the types of sending devices 10 with which the transmitter 12 is designed to operate. In the example discussed above, the transmitter 12 is coupled to a game system, such as a Sony Playstation 2. The ports 22 may be A/V input or output jacks, a USB port, serial port or other types of I/O ports.

One or more control circuits may also be provided. A control circuit 33 may interpret or convert signals from the sending device 10. The control circuit 33 may perform the operations to provide the signal from the port 22, for example a USB port, to the transmitter circuitry 24. Different control circuits may be provided for the different types of ports 22. The control circuit 33 may also be incorporated into the transmitter circuitry 24.

The signals from the sending device 10 are provided via the ports 22 to transmitter circuitry 24. The transmitter circuitry 24 prepares the signal to be transmitted in a wireless manner to the receiver 14. The transmitter circuitry 24 may include coder/decoders, modulators or other circuits and components required for wireless transmission, which circuits and components are known to those of ordinary skill in the art. The transmitter 12 can process the signals from the sending device 10 to prepare them for transmission, for example, via a 2.4 GHz wireless link. Of course other frequencies or other types of wireless transmission methods, such as infrared, etc, may also be used.

The signal encoded according to the wireless transmission method is then sent via antenna 28 to the receiver 14. For example, the signals output from the video game system that are typically provided directly to a television monitor to represent game play are instead provided to the transmitter 12. The signal is encoded and sent via antenna 28 to the receiver 14. The receiver 14 processes the signal and provides the processed signal to the receiving device 16, such as a television monitor.

Transmitter 12 may be powered via a power supply 30, such as one or more rechargeable batteries. The power supply 30 may provide power to the transmitter circuitry 24, control circuit 33, and to other components of the transmitter 12. Recharging circuit 32 is coupled to the power supply 30 and to a recharging port 34 provided on the housing 20. The recharging port 34 may include recharging contacts, a pin connector or the like. When the transmitter 12 is coupled to a docking station, discussed below, the recharging port 34 may be coupled to a corresponding portion of the docking station to receive charging power. The recharging circuit may be configured to receive either AC or DC power to charge power supply 44.

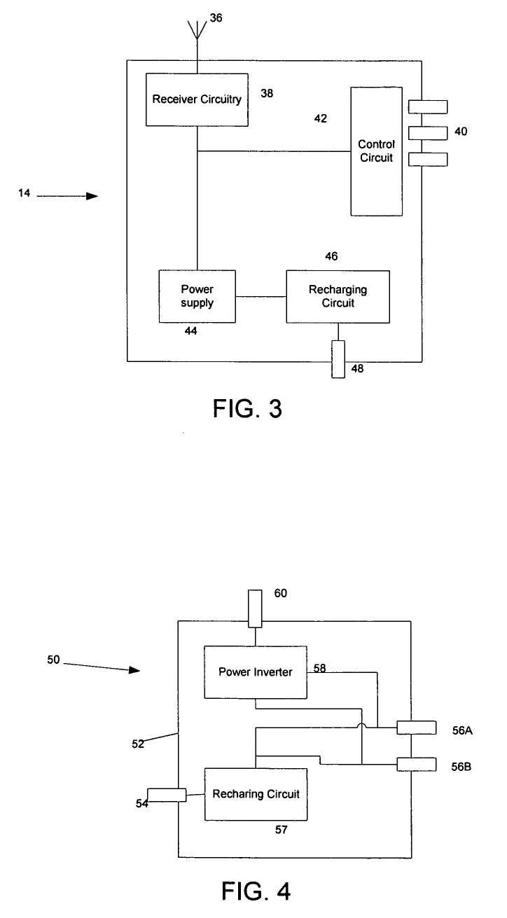

FIG. 3 illustrates an exemplary embodiment of a receiver 14 according to the invention. The receiver 14 includes a housing 34 enclosing various power, control, and receiver circuits. Receiver 14 includes an antenna 36 for receiving the wireless signals from the transmitter 12. The antenna 36, as well as antenna 28, may be any type of antenna, for example, a patch antenna, an antenna formed on a printed circuit board, etc. The wireless signals received by the antenna 36 are provided to receiver circuitry 38. The receiver circuitry 38 processes the wireless signals, for example by decoding, demodulation or the like. Such receiver circuitry is well known to those of ordinary skill in the art. The processed signal is provided via one or more ports 40 to a receiving device 16. The receiving device 16 may be, for example, a TV, DVD, VCR, camcorder, stereo, satellite system, game system, etc. The ports 40 may take various forms depending on what type of input signals the receiving device 14 is capable of receiving. For example, the port 40 may include USB ports, serial ports, A/V ports, coaxial cable ports, etc.

One or more control circuits may also be provided in the receiver 14. A control circuit 42 may convert the processed signal from the receiver circuitry 38 into the appropriate format to be communicated to the receiving device 16 via ports 40. The control circuit 42 may perform the necessary operations to provide signals to the receiving device 16 via a USB port, for example. Different control circuits may be provided for different types of ports 40. The control circuit 42 may also be incorporated into the receiver circuitry 38.

Similar to the transmitter 12, receiver 14 may be powered via a power supply 44, such as one or more rechargeable batteries. The power supply 44 may provide power to the receiver circuitry 38 and other components of the receiver 14. Recharging circuit 46 is coupled to the power supply 44 and to recharging port 48 provided on the housing 34. When the receiver 14 is coupled to the docking station, discussed below, the recharging port 48 may be coupled to corresponding recharging port 54 on the docking station 50. The recharging circuit may be configured to receive either AC or DC power to charge power supply 44.

An example of a docking station 50 according to an embodiment of the invention is depicted in FIG. 4. The docking station 50 includes a housing 52. The housing 52 may protect the electronic and other components of the docking station 50. The housing 52 includes a recharging port 54. The recharging port 54 may be adapted to be coupled to the respective recharging ports on the transmitter 12 or receiver 14. More than one recharging port and associated circuitry may be provided to allow the transmitter and receiver to be charged simultaneously. Power to charge the power supplies 30, 44 is supplied from the docking station 50 to the transmitter 12 or receiver 14 via the recharging port 54. The recharging port 54 may comprise one or more contacts, pins or the like. The housing 52 of the docking station may be configured to receive the housings of the transmitter 12 and receiver 14 in a secure manner so that contact between the recharging ports 34, 48 and 54 is maintained during a charging operation.

The docking station 50 may include inputs 56A, 56B adapted to receive power from various sources. In the embodiment shown in FIG. 4, the docking station 50 includes an input 56A for receiving DC power, for example 12 volt DC power from a cigarette lighter adapter. The docking station 50 may also include an input 56B for receiving power from a wall cube that may be plugged into a typical AC wall outlet. Either of these or other power supplies may be used as the recharging power source. Power is provided from the inputs 56A, 56B to the recharging circuitry 57 and eventually to the transmitter 12 or receiver 14. Accordingly, recharging can be performed from either of an AC or DC power source.

The docking station 50 may include power inverter circuitry that can convert DC input power into AC output power. For example, as mentioned above, the docking station 50 may include an input for receiving DC input power, for example via a cigarette lighter adapter. The DC input power can be converted by power inverter 58 into AC output power to power various devices, such as a television monitor or game system. An AC power outlet 60 may be provided for this purpose.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A wireless system comprising:
a transmitter comprising:
a housing;
at least one input port on the housing to receive input signals from a sending device;
transmitter circuitry, disposed in the housing, coupled to the input ports and configured to process the signals for wireless transmission;
an antenna coupled to the transmitter circuitry and configured to wirelessly transmit the processed signals;
a power supply disposed in the housing and coupled to the transmitter circuitry; and
charging circuitry disposed in the housing and coupled to the power supply;
a recharging port on the housing coupled to the charging circuit and configured to receive recharging power; and
a receiver comprising:
a housing;
an antenna configured to receive the wirelessly transmitted signals from the transmitter;
receiver circuitry, disposed in the housing, coupled to the antenna and configured to process the received signals;
output ports on the housing, coupled to the receiver circuitry and configured to be coupled to a receiving device;
a power supply disposed in the housing and coupled to the receiver circuitry; and
a charging circuit disposed in the housing and coupled to the power supply; and
a recharging port, on the housing, coupled to the charging circuit and configured to receive recharging power.

2. The transmitter of claim 1 further comprising a control circuit, disposed between the input ports and the transmitter circuitry, to convert the signals from the input ports into a signal compatible with the transmitter circuitry.

3. The transmitter of claim 1 wherein the input ports to receive input signals are configured to receive various types of sending devices that are not configured to wirelessly communicate.

4. The transmitter of claim 1 wherein the input ports are at least one of: an input jack, a USB port, or a serial port.

5. The transmitter of claim 1 wherein the transmitter circuitry includes at least one of: a coder, a decoder, or a modulator.

6. The transmitter of claim 1 wherein the processed signal is wirelessly transmitted via at least one of a 2.4 GHz or an infrared wireless link.

7. The transmitter of claim 1 wherein the power supply is comprised of one or more rechargeable batteries.

8. The transmitter of claim 1 wherein the recharging port is at least one of a recharging contact or a pin connector.

9. The transmitter of claim 1 wherein the antenna is at least one of a patch antenna or an antenna formed on a printed circuit board.

10. The receiver of claim 1 further comprising a control circuit, disposed between the output ports and the receiver circuitry, to convert the signals from the output ports into a signal compatible with the receiver circuitry.

11. The receiver of claim 10 wherein the control circuitry is configured to convert the processed signal from the receiver circuitry into one or more of a variety of output formats.

12. The receiver of claim 1 wherein the output ports are configured to connect to various types of receiving devices that are not configured to wirelessly communicate.

13. The receiver of claim 1 wherein the output ports are at least one of: an input jack, a USB port, or a serial port.

14. The receiver of claim 1 wherein the receiver circuitry includes at least one of: a coder, a decoder, or a modulator.

15. The receiver of claim 1 wherein the power supply is comprised of one or more rechargeable batteries.

16. The receiver of claim 1 wherein the recharging port is at least one of a recharging contact or a pin connector.

17. The receiver of claim 1 wherein the antenna is at least one of a patch antenna or an antenna formed on a printed circuit board.

18. A docking station for a wireless transmitter or receiver, comprising:
a housing;
a power input on the housing configured to receive AC or DC input power;
a recharging circuit, disposed in the housing, configured to receive AC or DC input power from power input and output DC charging power;
a recharging port, disposed in the housing, having an output and configured to receive the DC charging power of the recharging circuit and to be coupled to a corresponding recharging port on a wireless transmitter or a wireless receiver; and
a power inverter, disposed in the housing, coupled to the AC or DC input power and providing an AC power output.
an AC output port, disposed on the housing, coupled to the power inverter and receiving the AC power output.

19. The docking station of claim 18 wherein the power input is able to receive both AC and DC power.

20. The docking station of claim 18 wherein the recharging circuit is able to receive both AC and DC power and output DC charging power.

21. The docking station of claim 18 wherein the housing is configured to receive the housing of one or both of the wireless transmitter and receiver.

22. The docking station of claim 18 wherein the power input is configured to receive DC power from an automobile cigarette lighter adaptor.

23. The docking station of claim 18 wherein the power input is configured to receive AC power from a wall socket.
